(19) United States
(12) Patent Application Publication
(10) Pub. No.: US 2025/0315067 A1
(43) Pub. Date: Oct. 9, 2025

(54) FLUID CONTROL DEVICE, CONTROL METHOD FOR A FLUID CONTROL VALVE, FLUID CONTROL METHOD, AND FLUID CONTROL PROGRAM

(71) Applicant: HORIBA STEC, Co., Ltd., Kyoto (JP)

(72) Inventors: Yugo NAKAYA, Kyoto (JP); Hiroshi NISHIZATO, Kyoto (JP)

(73) Assignee: HORIBA STEC, Co., Ltd., Kyoto (JP)

(21) Appl. No.: 19/095,159

(22) Filed: Mar. 31, 2025

(30) Foreign Application Priority Data
Apr. 8, 2024 (JP) 2024-062131
Jul. 10, 2024 (JP) 2024-110791

(51) Int. Cl. G05D 7/06

(52) U.S. Cl. CPC G05D 7/0623; G05D 7/0635

(57) ABSTRACT

The present invention reduces damage to a valve seat surface or a valve body that occurs when a fluid control valve is fully closed, and is provided with a fluid control valve in which a distance between a valve seat surface and a valve body varies in accordance with a value of a drive signal, and a control mechanism that outputs the drive signal so as to control the fluid control valve. In a case in which the fluid control valve is to be fully closed, the control mechanism outputs to the fluid control valve a drive signal that causes the fluid control valve to temporarily stop prior to being placed in the fully closed state, and thereafter outputs to the fluid control valve a drive signal that causes the fluid control valve to be placed in the fully closed state.

### CROSS-REFERENCE TO RELATED APPLICATIONS

The present application claims priority of Japanese Application No. 2024-062131, filed Apr. 8, 2024, and Japanese Application No. 2024-110791, filed Jul. 10, 2024, the entire contents of which are hereby incorporated by reference in their entireties.

### BACKGROUND OF THE INVENTION

### 1. Technical Field

The present invention relates to a fluid control device, a control method for a fluid control valve, a fluid control method, and a fluid control program.

### 2. Description of the Related Art

In a semiconductor manufacturing process, for example, a fluid control device is used for controlling a flow rate of a material gas or the like. This fluid control device is provided with a fluid control valve in which a distance between a valve seat surface and a valve body varies in accordance with the value of a drive signal, and with a control mechanism that outputs the drive signal so as to control the fluid control valve.

However, in a case in which the fluid control valve is switched from an open state to a fully closed state, the valve body and the valve seat surface strike against each other and there is a possibility that the valve seat surface or a surface (i.e., a seating surface) of the valve body will be damaged by this impact. If the valve seat surface or the seating surface is damaged, this damage may cause leaks to occur when the fluid control valve is in a fully closed state.

Moreover, depending on the application of the fluid control device, there may also be cases in which the fluid control valve is switched within a short period of time from an open state to a fully closed state, or cases in which the fluid control valve is switched repeatedly between an open state and a closed state at a predetermined cycle. If the responsiveness is improved in cases such as these, then there is an increase in overshoot, and a decrease in attenuation. As a result, due to this overshoot or to vibration in the transient response, the valve seat surface ends up being pressed into the valve body, and the valve seat surface or the seating surface may be easily damaged.

As is shown in Patent Document 1, in order to counter this, reducing the speed of movement of the valve body after the distance between the valve seat surface and the valve body has decreased to within a predetermined distance may be considered. However, because the valve body continues to approach closer to the valve seat surface even after the speed of movement thereof has been reduced, there remains a possibility that the valve body will come into contact with the valve seat surface because of overshoot or vibration in the transient response that occur in the instant when the speed of movement is reduced.

### PRIOR ART DOCUMENT

### Patent Document

Patent Document 1: Japanese Patent Application Laid-Open NO. 2018-206387

### SUMMARY OF THE INVENTION

The present invention was, therefore, conceived in order to solve the above-described problem, and it is a principal object thereof to reduce damage to a valve seat surface or a valve body that occurs when a fluid control valve is fully closed.

In other words, a fluid control device according to the present invention is provided with a fluid control valve in which a distance between a valve seat surface and a valve body varies in accordance with a value of a drive signal, and a control mechanism that outputs the drive signal so as to control the fluid control valve, and is characterized in that, in a case in which the fluid control valve is to be fully closed, the control mechanism outputs to the fluid control valve a drive signal that causes the fluid control valve to temporarily stop prior to being placed in the fully closed state, and thereafter outputs to the fluid control valve a drive signal that causes the fluid control valve to be placed in the fully closed state.

According to a fluid control device having this structure, in a case in which the fluid control valve is to be fully closed, because the fluid control valve is only placed in a fully closed state after it has firstly been temporarily stopped, compared with a case in which the fluid control valve is placed in a fully closed state in a single movement, it is possible to reduce the impact applied to the valve seat surface and the valve body. In addition, it is possible to reduce the extent to which the valve seat surface is pressed into the valve body due to overshoot or to vibration in the transient response. As a result, it is possible to reduce any damage to the valve seat surface or the valve body that might be caused by this.

Moreover, it is also possible to consider a structure in which, in a case in which the fluid control valve is to be a fully closed, prior to the fluid control valve being placed in the fully closed state, the control mechanism outputs to the fluid control valve a drive signal that causes the fluid control valve to temporarily stop when the distance between the valve seat surface and the valve body is a predetermined distance, and thereafter outputs to the fluid control valve a drive signal that causes the fluid control valve to be placed in the fully closed state.

If this structure is employed, then because the fluid control valve is temporarily stopped when the distance between the valve seat surface and the valve body is a predetermined distance, compared with control that reduces the speed of movement of the valve body, it is possible to reduce the possibility of the valve body coming into contact with the valve seat surface due to overshoot or to vibration in the transient response.

In order to reduce the possibility of the valve body coming into contact with the valve seat surface due to the overshoot that is generated in the transition from a state in which the distance between the valve seat surface and the valve body is a predetermined distance (i.e., from a temporary stop state) to a fully closed state, it is desirable that the predetermined distance is a distance that does not allow the valve body to come into contact with the valve seat surface due to overshoot that is generated when the fluid control valve is temporarily stopped at the predetermined distance.

In order to reduce the impact that is applied to the valve seat surface and the valve body when the fluid control valve is placed in the fully closed state, it is desirable that, in a state in which the distance between the valve seat surface and the valve body is a predetermined distance, the control mechanism output to the fluid control valve a drive signal to cause the fluid control valve to switch to the fully closed state after any vibration caused by a transient response has converged to within a predetermined value or less.

In the valve body, the seating surface of that is seated on the valve seat surface may be formed by a resin layer. In this structure, in a case in which the fluid control valve is to be fully closed, it is desirable that, prior to the fluid control valve being placed in the fully closed state, the control mechanism output to the fluid control valve a drive signal that causes the fluid control valve to temporarily stop in a state in which the valve seat surface and the seating surface are either in mutual contact or are mutually adjacent, and thereafter, output to the fluid control valve a drive signal that causes the fluid control valve to be placed in the fully closed state in which the valve seat surface is pressed further into the seating surface.

If this structure is employed, then because the fluid control valve is temporarily stopped when the valve seat surface and the seating surface are either in mutual contact or are mutually adjacent prior to the fluid control valve being placed in the fully closed state, and thereafter the fluid control valve is placed in the fully closed state in which the valve seat surface is pressed further into the seating surface, it is possible to improve the response speed of the full closing operation.

It is also desirable that the control mechanism perform pulse control so as to cause the fluid control valve to switch repeatedly between an open state and a fully closed state.

If this structure is employed, then as is described above, because the fluid control valve is temporarily stopped at the predetermined distance when switching from an open state to a fully closed state even in a case in which, due to the pulse control, the impact between the valve seat surface and the valve body is repeated cyclically, it is possible to reduce any damage to the valve seat surface or the valve body that may be caused by this.

In order to reduce any overshoot or vibration in the transient response that is generated when the distance between the valve seat surface and the valve body changes from the predetermined distance (i.e., from the temporary stop state) to the fully closed state, it is desirable that the predetermined distance be not more than 30% of the stroke length from a fully open state to the fully closed state.

It is also desirable that, in a case in which the fluid control valve is to be fully closed, the control mechanism outputs to the fluid control valve a step-shaped drive signal that causes the fluid control valve to temporarily stop.

If this structure is employed, then it is possible to reduce the time from an open state such as, for example, a fully open state, until the time when the fluid control valve is temporarily stopped. Accordingly, it is possible to switch from an open state to a fully closed state in a short period of time while also reducing damage that might be caused to the valve seat surface or the valve body.

It is also desirable that, in a case in which the fluid control valve is to be fully closed, the control mechanism outputs to the fluid control valve a step-shaped drive signal that places the fluid control valve in a fully closed state after firstly causing the fluid control valve to temporarily stop.

If this structure is employed, then it is possible to reduce the time from when the distance between the valve seat surface and the valve body has been temporarily stopped at a predetermined distance until the fluid control valve is placed in a fully closed state. Accordingly, it is possible to switch from an open state to a fully closed state in a short period of time while also reducing damage that might be caused to the valve seat surface or the valve body.

Furthermore, a control method for a fluid control valve according to the present invention is a control method for a fluid control valve in which a fluid control valve in which a distance between a valve seat surface and a valve body varies in accordance with a value of a drive signal is controlled as a result of the drive signal being output to the fluid control valve, and is characterized in that, in a case in which the fluid control valve is to be fully closed, a drive signal that causes the fluid control valve to temporarily stop prior to being placed in the fully closed state is output to the fluid control valve, and thereafter a drive signal that causes the fluid control valve to be placed in the fully closed state is output to the fluid control valve.

Furthermore, a fluid control method according to the present invention is a fluid control method in which a fluid control valve in which a distance between a valve seat surface and a valve body varies in accordance with a value of a drive signal is controlled as a result of the drive signal being output to the fluid control valve, and in which, in a case in which the fluid control valve is to be fully closed, a drive signal that causes the fluid control valve to temporarily stop prior to being placed in the fully closed state is output to the fluid control valve, and thereafter a drive signal that causes the fluid control valve to be placed in the fully closed state is output to the fluid control valve.

In addition, a fluid control program according to the present invention is fluid control program that controls a fluid control valve in which a distance between a valve seat surface and a valve body varies in accordance with a value of a drive signal is controlled as a result of the drive signal being output to the fluid control valve, and is characterized in that, in a case in which the fluid control valve is to be fully closed, the fluid control program causes a computer to perform functions of outputting to the fluid control valve a drive signal that causes the fluid control valve to temporarily stop prior to being placed in the fully closed state, and thereafter outputting to the fluid control valve a drive signal that causes the fluid control valve to be placed in the fully closed state.

Note that this fluid control program may be distributed electronically, or may be recorded on a program recording medium such as a CD, DVD, or flash memory stick or the like.

According to the present invention which is structured in the manner described above, it is possible to reduce damage to a valve seat surface or a valve body that occurs when a fluid control valve is fully closed.

### BRIEF DESCRIPTION OF THE DRAWINGS

FIG. 1 is a schematic view showing a structure of a fluid control device according to an embodiment of the present invention;

FIG. 2 is a view showing a drive signal of the same embodiment;

FIG. 3 is an enlarged view of the drive signal of the same embodiment showing a drive signal that is used to place a fluid control valve in a fully closed state;

FIG. 4 is a view showing a (slope-shaped) drive signal of a variant embodiment;

FIG. 5 is a view showing a drive signal having multi-stage stops of a variant embodiment;

FIG. 6 is a schematic view showing a structure of a fluid control device according to a variant embodiment; and

FIG. 7 is a view showing (a) respective states of a valve seat surface and a valve body, and (b) drive signals according to a variant embodiment.

### DETAILED DESCRIPTION

Hereinafter, an embodiment of a fluid control device according to the present invention will be described with reference to the drawings. Note that, in order to simplify an understanding thereof, each of the drawings depicted below is shown schematically with omissions or enhancements made where these have been deemed appropriate. In addition, component elements that are the same in the respective drawings are indicated by the same descriptive symbols and any duplicated description thereof is omitted.

A fluid control device 100 according to the present embodiment is used, for example, to perform flow rate control of a material gas or the like in a semiconductor manufacturing process. For example, this fluid control device 100 is used to control the flow rate of a material gas (i.e., a precursor) that is supplied to a thin film formation process such as an atomic layer deposition (ALD) process or the like.

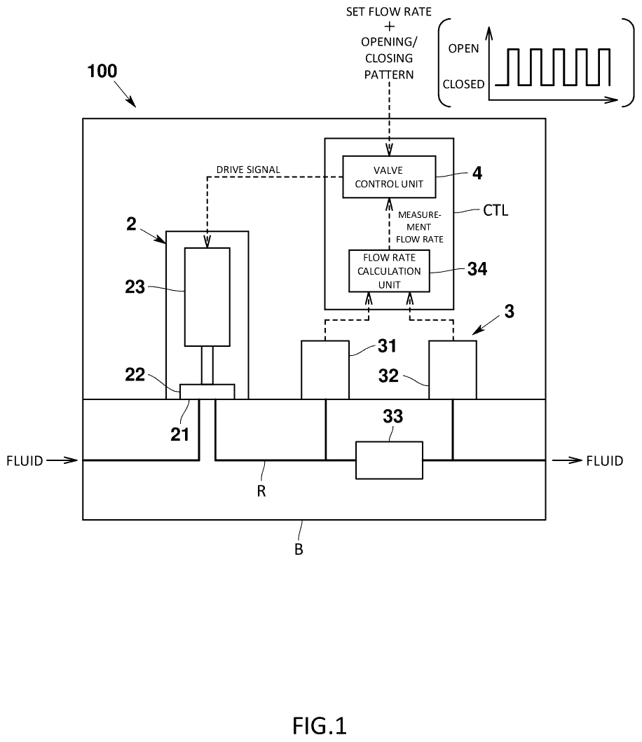

More specifically, the fluid control device 100 is what is known as a mass flow controller and, as is shown in FIG. 1, is provided with a flow path block B having a rectangular parallelepiped shape and in which is formed an internal flow path R, a fluid control valve 2 that is mounted on the flow path block B, a flow rate sensor 3 that measures a flow rate of a fluid flowing through the internal flow path R, and a control mechanism CTL that controls a valve opening of the fluid control valve 2 based on an output from the flow rate sensor 3.

The fluid control valve 2 is provided with a valve seat surface 21, a valve body 22 that moves towards and away from the valve seat surface 21, and an actuator 23 that drives the valve body 22. In this fluid control valve 2, the flow rate is controlled as a result of a distance between the valve seat surface 21 and the valve body 22 being varied in accordance with a value of a drive signal output from the control mechanism CTL.

More specifically, the fluid control valve 2 is what is known as a normally closed valve. In a state in which the actuator 23 is not being driven (i.e., in a state in which no drive voltage that is serving as a drive signal is being applied thereto), the fluid control valve 2 is in a fully closed state in which the valve body 22 is in contact with the valve seat surface 21. Note that the valve body 22 is urged in the closing direction by an elastic body such as a plate spring or the like.

When the actuator 23 is driven (i.e., in a state in which drive voltage is being applied thereto), the fluid control valve 2 is placed in an open state in which the valve body 22 is separated from the valve seat surface 21. The distance between the valve seat surface 21 and the valve body 22 (i.e., the valve opening) is adjusted by the piezo actuator 23 so as to control the flow rate of a fluid.

The flow rate sensor 3 is a pressure-based sensor that is provided on an upstream side or a downstream side of the fluid control valve 2. The flow rate sensor of the present embodiment is provided on the downstream side of the fluid control valve 2. The flow rate sensor 3 is provided with a first pressure sensor 31 and a second pressure sensor 32 that are disposed respectively on the upstream side and the downstream side of a laminar flow element 33, and with a flow rate calculation unit 34 that calculates a flow rate based on outputs from the first pressure sensor 31 and the second pressure sensor 32. The first pressure sensor 31 and the second pressure sensor 32 are mounted on the flow path block B in line with the fluid control valve 2. Moreover, the flow rate calculation unit 34 of the present embodiment is formed by utilizing an arithmetic function of the control mechanism CTL, however, it may also be provided separately from the control mechanism CTL.

The control mechanism CTL is a computer that is equipped with a CPU, internal memory, input and output interfaces, an A/D converter, and a communication device and the like. The control mechanism CTL performs the functions of the valve control unit 4 described below as a result of the CPU and peripheral devices operating in mutual collaboration with each other in accordance with a fluid control program that is stored in the internal memory.

The valve control unit 4 controls the fluid control valve 2 by outputting a drive signal in the form of drive voltage to the actuator 23.

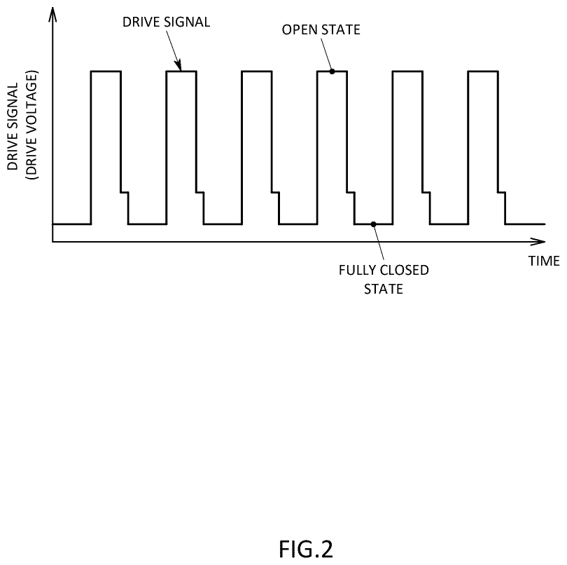

Based on an opening/closing pattern set by a user, for example, the valve control unit 4 of the present embodiment performs pulse control so as to cause the fluid control valve 2 to cycle repeatedly between an open state such as a fully open state or the like and a fully closed state. As is shown in FIG. 2, this pulse control unit 4 outputs to the actuator 23 a drive signal in which a predetermined valve opening signal (i.e., an ON signal) and a fully closed signal (i.e., an OFF signal) are repeated alternatingly at a predetermined cycle. Note that the predetermined valve opening signal is determined based on a set flow rate. In a case in which fluid control valve 2 is to be placed in an open state, the valve control unit 4 performs feedback control based on a deviation between a measurement flow rate measured by the flow rate sensor 3 and a set flow rate.

In a case in which the fluid control valve 2 is to be fully closed, the valve control unit 4 performs control so as to lessen the impact that is applied to the valve seat surface 21 and the valve body 22.

More specifically, in a case in which the fluid control valve 2 is to be fully closed, the valve control unit 4 outputs a drive signal to the fluid control valve 2 that causes the impact that is applied to the valve seat surface 21 and the valve body 22 to be decreased.

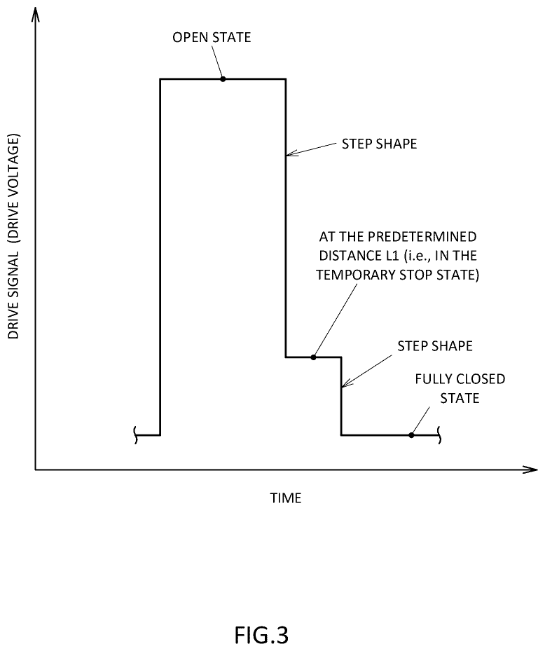

This will now be described in further detail. In a case in which the fluid control valve 2 is to be fully closed, prior to the fluid control valve 2 being placed in the fully closed state, the valve control unit 4 outputs to the fluid control valve 2 a drive signal that causes the fluid control valve 2 to temporarily stop at a point when the distance between the valve seat surface 21 and the valve body 22 is a predetermined distance L1. Thereafter, the valve control unit 4 outputs to the fluid control valve 2 a drive signal that causes the fluid control valve 2 to be placed in the fully closed state. In other words, as is shown in FIG. 3, in a case in which the fluid control valve 2 is to be fully closed, the drive signal causes the movement of the valve body 22 to be temporarily stopped in a state in which the distance between the valve seat surface 21 and the valve body 22 is the predetermined distance L1, and then after this temporary stop, causes the fluid control valve 2 to be placed in the fully closed state.

Here, the predetermined distance L1 where the valve body 22 is temporarily stopped is, for example, 30% or less of a stroke distance from the open state to the fully closed state. More specifically, the predetermined distance L1 is a distance that does not allow the valve body 22 to come into contact with the valve seat surface 21 due to the overshoot that is generated when the fluid control valve 2 is temporarily stopped at the predetermined distance L1. Note that it is also possible for the predetermined distance L1 to be a variable distance that is varied in accordance with the valve opening of the open state.

Moreover, in a state in which the distance between the valve seat surface 21 and the valve body 22 is the predetermined distance L1 (i.e., in the temporary stop state), after any vibration in the valve body 22 caused by the transient response has converged to within a predetermined value or less, the valve control unit 4 outputs to the fluid control valve 2 a drive signal that causes the fluid control valve 2 to switch to the fully closed state. In other words, the length of time of the temporary stop is the length of time that elapses until the vibration in the valve body 22 caused by the transient response has converged to within the predetermined value or less. In this manner, by placing the fluid control valve 2 in the fully closed state only after any vibration in the valve body 22 caused by the transient response has converged to within a predetermined value or less, it is possible to lessen any impact that is applied to the valve seat surface 21 and the valve body 22 when the fluid control valve 2 is being placed in the fully closed state.

At this time, it is also possible to consider a structure in which the valve control unit 4 outputs to the fluid control valve 2 the drive signal that places the fluid control valve 2 in the fully closed state once the predetermined convergence time that is required until the vibration in the valve body 22 caused by the transient response has converged to within the predetermined value or less has elapsed. This convergence time can be determined in advance by analyzing the fluid control valve 2.

Moreover, in a case in which the fluid control valve 2 is formed having a position sensor (not shown in the drawings) that detects a position of the valve body 22, then it is also possible to consider a structure in which the valve control unit 4 outputs to the fluid control valve 2 the drive signal that places the fluid control valve 2 in the fully closed state once the valve control unit 4 has detected that the vibration caused by the transient response has converged to within the predetermined value or less using a position detection performed by this position sensor.

Furthermore, in a case in which the fluid control valve 2 is to be fully closed, the valve control unit 4 outputs to the fluid control valve 2 a step-shaped drive signal that causes the distance between the valve seat surface 21 and the valve body 22 to switch from an open state to the predetermined distance L1. Furthermore, in a case in which the fluid control valve 2 is to be fully closed, the valve control unit 4 outputs to the fluid control valve 2 a step-shaped drive signal that causes the fluid control valve 2 to be placed in the fully closed state after the distance between the valve seat surface 21 and the valve body 22 has been switched to the predetermined distance L1 (i.e., after the fluid control valve 2 has been placed in the temporary stop state).

### Effects Obtained From the Present Embodiment

According to the fluid control device 100 of the present embodiment that is formed in the manner described above, in a case in which the fluid control valve 2 is to be fully closed, because the fluid control valve 2 is placed in the fully closed state after having been temporarily stopped in a state in which the distance between the valve seat surface 21 and the valve body 22 is the predetermined distance L1, compared with a case in which the fluid control valve 2 is placed in a fully closed state in a single movement, it is possible to reduce the impact applied to the valve seat surface 21 and the valve body 22. In addition, it is possible to reduce the extent to which the valve seat surface is pressed into the valve body due to overshoot or to vibration in the transient response. As a result, it is possible to reduce any damage to the valve seat surface 21 or the valve body 22 that might be caused by this.

Moreover, because the valve control unit 4 outputs to the fluid control valve 2 a step-shaped drive signal as the drive signal that causes the distance between the valve seat surface 21 and the valve body 22 to switch from an open state to the predetermined distance L1, it is possible to reduce the time from an open state such as, for example, a fully open state, until the time when the distance between the valve seat surface 21 and the valve body 22 reaches the predetermined distance L1. Accordingly, it is possible to switch from an open state to a fully closed state in a short period of time while also reducing damage that might be caused to the valve seat surface 21 or the valve body 22.

Furthermore, because the valve control unit 4 outputs to the fluid control valve 2 a step-shaped drive signal as the drive signal that places the fluid control valve 2 in the fully closed state after having been temporarily stopped at the predetermined distance L1, it is possible to reduce the time from when the distance between the valve seat surface 21 and the valve body 22 has been temporarily stopped at a predetermined distance L1 until the fluid control valve 2 is placed in a fully closed state. Accordingly, it is possible to switch from an open state to a fully closed state in a short period of time while also reducing damage that might be caused to the valve seat surface 21 or the valve body 22.

### Additional Embodiments

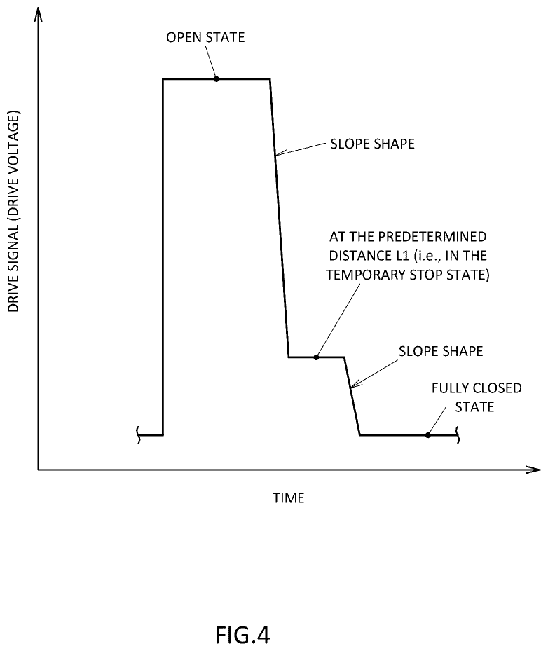

The drive signal employed in the present embodiment is formed, for example, in a step shape in which the steps are located before and after the temporary stop, however, as is shown in FIG. 4, it is also possible for a slope to be formed before and/or after the temporary stop. Note that the inclination of the slope formed before the temporary stop may be the same as the inclination of the slope formed after the temporary stop, or may be different therefrom.

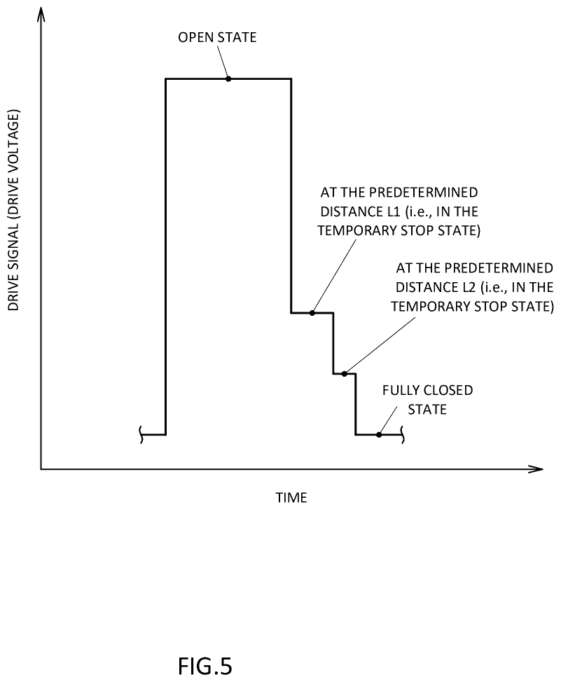

The valve control unit 4 is also formed such that, in a case in which the fluid control valve 2 is to be fully closed, the valve seat surface 21 and the valve body 22 are temporarily stopped once at the predetermined distance L1, however, as is shown in FIG. 5, it is also possible for a plurality of predetermined distances to be set (for example, L1, L2 (<L1), . . . ) and for the fluid control valve 2 to be temporarily stopped a plurality of times. Note that the times for which the fluid control valve 2 is stopped at each of the plurality of distances may be the same as each other, or may be different than each other.

The valve control unit 4 of the above-described embodiment performs pulse control of the fluid control valve 2, however, it is also possible for the valve control unit 4 to instead perform a different type of control than pulse control.

The fluid control valve 2 of the above-described embodiment is a normally closed type of valve, however, it is also possible for a normally open type of valve to be used instead. In such a case, in a state in which the actuator 23 is not being driven (i.e., in a state in which the drive voltage serving as the drive signal is not being applied), the fluid control valve 2 is in a fully open state in which the valve body 22 is separated from the valve seat surface 21.

The flow rate sensor of the above-described embodiment is a pressure-based sensor, however, it is also possible for a thermal sensor to be used.

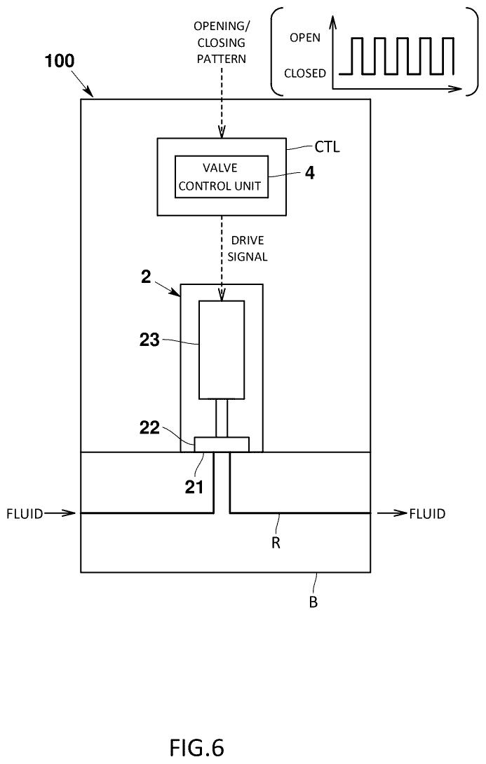

Moreover, the fluid control device 100 of the above-described embodiment is provided with the flow rate sensor 3, and performs feedback control of the fluid control valve 2 based on measurement flow rates from the flow rate sensor 3, however, as is shown in FIG. 6, it is also possible to employ a structure in which no flow rate sensor is provided. In this case, the valve control unit 4 controls the fluid control valve 2 using drive signals that are based on an opening/closing pattern set by a user (for example, based on a pattern that repeatedly switches between an open state such as a fully open state and a fully closed state). In this case, in the same way as in the above-described embodiment, in a case in which the fluid control valve 2 is to be fully closed, the valve control unit 4 causes the movement of the valve body 22 to be temporarily stopped in a state in which the distance between the valve seat surface 21 and the valve body 22 is the predetermined distance L1, and then after this temporary stop, causes the fluid control valve 2 to be placed in the fully closed state.

Furthermore, in a case in which the fluid control valve 2 is provided with a position sensor (not shown in the drawings) that detects the position of the valve body 22, then it is also possible to employ a structure in which this position sensor is used to detect a predetermined open state such as a fully open state or the like, and a fully closed state. In addition, it is also possible to employ a structure in which the valve control unit 4 controls the fluid control valve 2 based on positions detected by this position sensor. In this case, in a case in which the fluid control valve 2 is to be fully closed, the valve control unit 4 detects that the distance between the valve seat surface 21 and the valve body 22 is the predetermined distance L1 using this position sensor, and causes the movement of the valve body 22 to be temporarily stopped in a state in which the distance between the valve seat surface 21 and the valve body 22 is the predetermined distance L1, and then after this temporary stop, causes the fluid control valve 2 to be placed in the fully closed state.

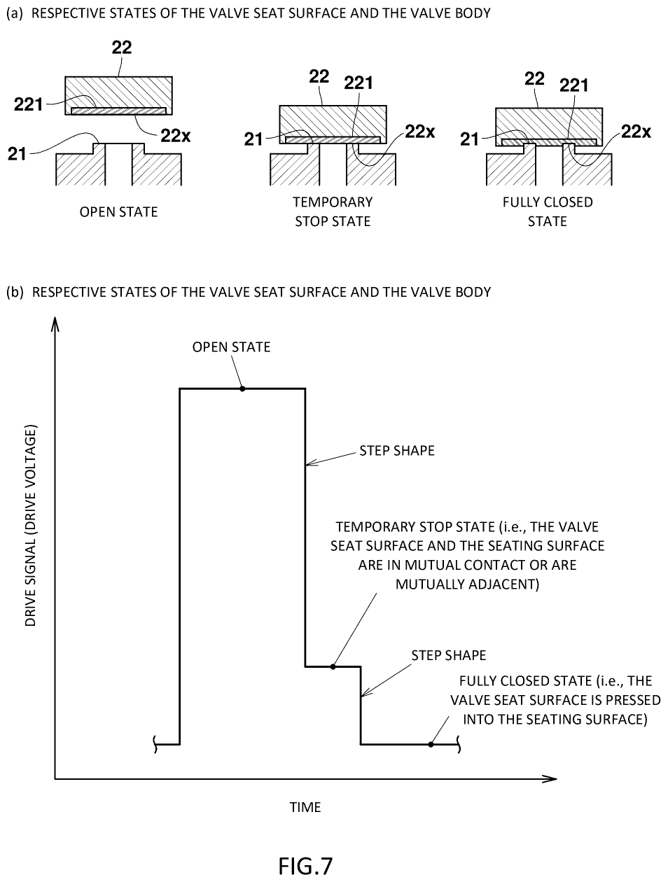

Moreover, as is shown in FIG. 7, in the valve body 22, it is also possible for a seating surface 22x that is seated on the valve seat surface 21 to be formed by a resin layer 221. In this case, it is possible to consider employing a structure in which, in a case in which the fluid control valve 2 is to be fully closed, prior to the fluid control valve 2 being placed in the fully closed state, the control mechanism CTL outputs to the fluid control valve 2 a drive signal that causes the fluid control valve 2 to temporarily stop in a state in which the valve seat surface 21 and the seating surface 22x are either in mutual contact or are mutually adjacent, and thereafter, outputs to the fluid control valve 2 a drive signal that causes the fluid control valve 2 to be placed in the fully closed state in which the valve seat surface 21 is pressed into the seating surface 22x.

Here, the description ‘a state in which the valve seat surface 21 and the seating surface 22x are either in mutual contact or are mutually adjacent prior to the fluid control valve 2 being placed in the fully closed state” is what is known as a ‘soft-closed state’, and is a state in which, for example a minimum value of a gas flow rate of nitrogen gas or the like is 0.0009 [SLM]. Moreover, the description ‘a fully closed state’ is what is known as ‘a hard-closed state’ in which the valve seat surface 21 is pressed firmly against the seating surface 22x, and is a state in which, for example, a leakage amount in a helium leakage test is 10⁻⁸˜⁻¹⁰[Pa·m³/sec].

If this structure is employed, then because the fluid control valve 2 is temporarily stopped when the valve seat surface 21 and the seating surface 22x are either in mutual contact or are mutually adjacent prior to the fluid control valve 2 being placed in the fully closed state, and thereafter the fluid control valve 2 is placed in the fully closed state in which the valve seat surface 21 is further pressed into the seating surface 22x, it is possible to improve the response speed of the full closing operation. Moreover, in order to prevent dents from being created in the resin layer 221 serving as the seating surface 22x of the valve body 22 through use so that leaks may start to occur, it is possible to adjust the drive signal (i.e., by lowering the voltage or the like) that is applied in order to place the fluid control valve 2 in a fully closed state so as to extend the usable lifespan of the valve body 22.

Furthermore, it should be understood that the present invention is not limited to the above-described embodiments, and that various modifications and the like may be made thereto insofar as they do not depart from the spirit or scope of the present invention.

### REFERENCE CHARACTERS LIST

100 Fluid Control Device
2 Fluid Control Valve
21 Valve Seat Surface
22 Valve Body
CTL Control Mechanism

What is claimed is:

1. A fluid control device comprising:
a fluid control valve in which a distance between a valve seat surface and a valve body varies in accordance with a drive signal; and
a control mechanism that outputs the drive signal so as to control the fluid control valve, wherein,
in a case in which the fluid control valve is to be fully closed, the control mechanism outputs to the fluid control valve a drive signal that causes the fluid control valve to temporarily stop prior to being placed in the fully closed state, and thereafter outputs to the fluid control valve a drive signal that causes the fluid control valve to be placed in the fully closed state.

2. The fluid control device according to claim 1, wherein, in a case in which the fluid control valve is to be fully closed, prior to the fluid control valve being placed in the fully closed state, the control mechanism outputs to the fluid control valve a drive signal that causes the fluid control valve to temporarily stop when the distance between the valve seat surface and the valve body is a predetermined distance, and thereafter outputs to the fluid control valve a drive signal that causes the fluid control valve to be placed in the fully closed state.

3. The fluid control device according to claim 2, wherein the predetermined distance is a distance that does not allow the valve body to come into contact with the valve seat surface due to overshoot that is generated when the fluid control valve is temporarily stopped at the predetermined distance.

4. The fluid control device according to claim 3, wherein, in a state in which the distance between the valve seat surface and the valve body is a predetermined distance, the control mechanism outputs to the fluid control valve a drive signal to cause the fluid control valve to switch to the fully closed state after any vibration caused by a transient response has converged to within a predetermined value or less.

5. The fluid control device according to claim 2, wherein the predetermined distance is not more than 30% of the stroke length from a fully open state to a fully closed state.

6. The fluid control device according to claim 1, wherein, in the valve body, a seating surface that is seated on the valve seat surface is formed by a resin layer, and,
in a case in which fluid control valve is to be fully closed, prior to the fluid control valve being placed in the fully closed state, the control mechanism outputs to the fluid control valve a drive signal that causes the fluid control valve to temporarily stop in a state in which the valve seat surface and the seating surface are either in mutual contact or are mutually adjacent, and thereafter, outputs to the fluid control valve a drive signal that causes the fluid control valve to be placed in the fully closed state in which the valve seat surface is pressed into the seating surface.

7. The fluid control device according to claim 1, wherein the control mechanism performs pulse control so as to cause the fluid control valve to switch repeatedly between an open state and a fully closed state.

8. The fluid control device according to claim 1, wherein, in a case in which the fluid control valve is to be fully closed, the control mechanism outputs to the fluid control valve a step-shaped drive signal that causes the fluid control valve to temporarily stop.

9. The fluid control device according to claim 1, wherein, in a case in which the fluid control valve is to be fully closed, the control mechanism outputs to the fluid control valve a step-shaped drive signal that places the fluid control valve in a fully closed state after firstly causing the fluid control valve to temporarily stop.

10. A control method for a fluid control valve in which a fluid control valve in which a distance between a valve seat surface and a valve body varies in accordance with a value of a drive signal is controlled as a result of the drive signal being output to the fluid control valve, wherein,
in a case in which the fluid control valve is to be fully closed, a drive signal that causes the fluid control valve to temporarily stop prior to being placed in the fully closed state is output to the fluid control valve, and thereafter a drive signal that causes the fluid control valve to be placed in the fully closed state is output to the fluid control valve.

11. A fluid control method in which a fluid control valve in which a distance between a valve seat surface and a valve body varies in accordance with a value of a drive signal is controlled as a result of the drive signal being output to the fluid control valve, wherein,
in a case in which the fluid control valve is to be fully closed, a drive signal that causes the fluid control valve to temporarily stop prior to being placed in the fully closed state is output to the fluid control valve, and thereafter a drive signal that causes the fluid control valve to be placed in the fully closed state is output to the fluid control valve.

12. A computer-readable medium including a fluid control program that controls a fluid control valve in which a distance between a valve seat surface and a valve body varies in accordance with a value of a drive signal is controlled as a result of the drive signal being output to the fluid control valve, wherein,
in a case in which the fluid control valve is to be fully closed, the fluid control program causes a computer to perform functions of outputting to the fluid control valve a drive signal that causes the fluid control valve to temporarily stop prior to being placed in the fully closed state, and thereafter outputting to the fluid control valve a drive signal that causes the fluid control valve to be placed in the fully closed state.
